(19) United States
(12) Patent Application Publication
(10) Pub. No.: US 2017/0335552 A1
(43) Pub. Date: Nov. 23, 2017

(54) WATER SAVING MECHANISM FOR A FAUCET

(71) Applicant: Xiamen Runner Industrial Corporation, Xiamen (CN)

(72) Inventors: ZHI-GUO JIANG, Xiamen (CN); YAN-XU SHEN, Xiamen (CN); XI-MIN CHEN, Xiamen (CN); YONG-YAN ZHOU, Xiamen (CN); JIN-FA WANG, Xiamen (CN)

(21) Appl. No.: 15/584,197

(22) Filed: May 2, 2017

(30) Foreign Application Priority Data
May 23, 2016 (CN) 201610342767.1

(51) Int. Cl. E03C 1/04; F16K 31/60

(52) U.S. Cl. CPC E03C 1/0412; F16K 31/60

(57) ABSTRACT

A faucet having a body with a core securely mounted thereon and a handle rotatably mounted on top of the core is provided with a recoil mechanism sandwiched between the handle and the body to drive the handle back to its original position as well as slow down return of the handle. The recoil mechanism includes a positioning seat snugly mounted on top of the core and a restoring spring a free end of which is securely connected to the positioning seat and the other free end of which is adapted to securely connect to the handle to drive the handle back to its original position after the handle is rotated.

### BACKGROUND OF THE INVENTION

### 1. Field of Invention

The present invention relates to a water saving mechanism and, more particularly, to a water saving mechanism for a faucet to reduce water waste.

### 2. Description of Related Art

Water is a necessity for our daily lives. Almost everything involves water. In the morning, we need water to brush our teeth, to wash our faces and to bath or shower. In the industry, water functions as a great cooling agent for machines that require running 24-7. Numerous embodiments exist our surroundings and cannot be named enough. As water is a natural resource and people consume a large amount of water daily in almost every aspect. It is a crucial lesson for people to learn to save this natural resource as it greatly affects our daily routines.

Even though we know this for a fact that the natural resources, especially water, is becoming less each day, people still unconsciously waste water in a way they don't even know they are wasting water. For example, when people are using a faucet, they tend to turn on the faucet with maximum volume to only rinse both hands, not knowing that only a little volume of water will just do the work. Afterwards, people don't turn off the faucet immediately after use. They subconsciously delay waterflow out of the faucet for maybe just a second, thinking they could use this water to clean the faucet as well as other accessories surrounding the faucet. Notwithstanding the foregoing, even if the cleaning purpose is achieved, a waste is a waste.

In order to mitigate the situation, it is an objective of the embodiment of the present invention to provide an automatically shut down mechanism for a faucet to greatly reduce water waste.

### SUMMARY OF THE INVENTION

It is an objective of the embodiment of the present invention to provide a faucet having a body with a core securely mounted thereon and a handle rotatably mounted on top of the core, wherein a recoil mechanism adapted to be sandwiched between the handle and the body to drive the handle back to its original position as well as slow down return of the handle.

Another objective of the embodiment of the present invention is that the recoil mechanism comprises a positioning seat snugly mounted on top of the core and a restoring spring a free end of which is securely connected to the positioning seat and the other free end of which is adapted to securely connect to the handle to drive the handle back to its original position after the handle is rotated.

Another objective of the embodiment of the present invention is that the positioning seat has at least one adjusting hole to receive therein a free end of the restoring spring and the handle has a positioning hole to receive therein the other free end of the restoring spring so that a recoil force is applied to the handle after the handle is rotated.

Another objective of the embodiment of the present invention is that the recoil mechanism further comprises a bracket sandwiched between the handle and the positioning seat, the bracket is threadingly connected to the positioning seat and in a ratchet connection to the handle.

Still another objective of the embodiment of the present invention is that the recoil mechanism further comprises a bracket sandwiched between the handle and the positioning seat, the bracket is threadingly connected to the positioning seat and in a ratchet connection to the handle.

Still another objective of the embodiment of the present invention is that the bracket has a rack formed on a top face thereon and a limit is adapted to be applied to the handle and has a threading formed thereon to correspond to and mate with the rack of the bracket so that when the restoring spring drives the handle back to its original position, the mated threading of the limit and the rack of the bracket slows down movement of the handle.

Still another objective of the embodiment of the present invention is that there are two adjusting holes in the positioning seat to selectively receive therein the free end of the restoring spring.

Still another objective of the embodiment of the present invention is that there are two adjusting holes in the positioning seat to selectively receive therein the free end of the restoring spring.

Still another objective of the embodiment of the present invention is that there are two adjusting holes in the positioning seat to selectively receive therein the free end of the restoring spring.

Still another objective of the embodiment of the present invention is that there are two adjusting holes in the positioning seat to selectively receive therein the free end of the restoring spring.

### BRIEF DESCRIPTION OF THE DRAWINGS

FIG. 1 is an exploded perspective view of the water saving mechanism constructed in accordance with the embodiment of the present invention; and

FIG. 2 is a cross sectional view showing a faucet equipped with the water saving mechanism of the embodiment of the present invention.

### DETAILED DESCRIPTION OF THE INVENTION

The technical characteristics and objectives of the present invention can be further understood by the following detailed description of preferred embodiment(s) and related drawings.

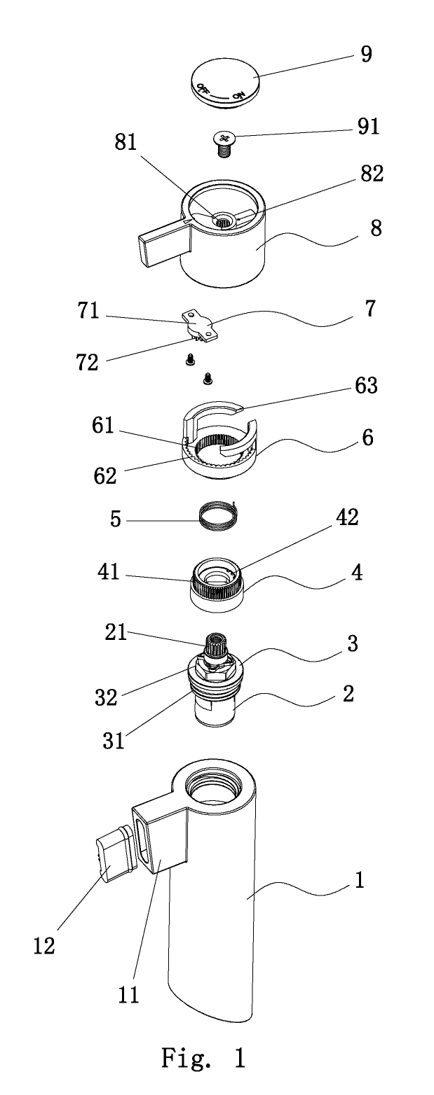

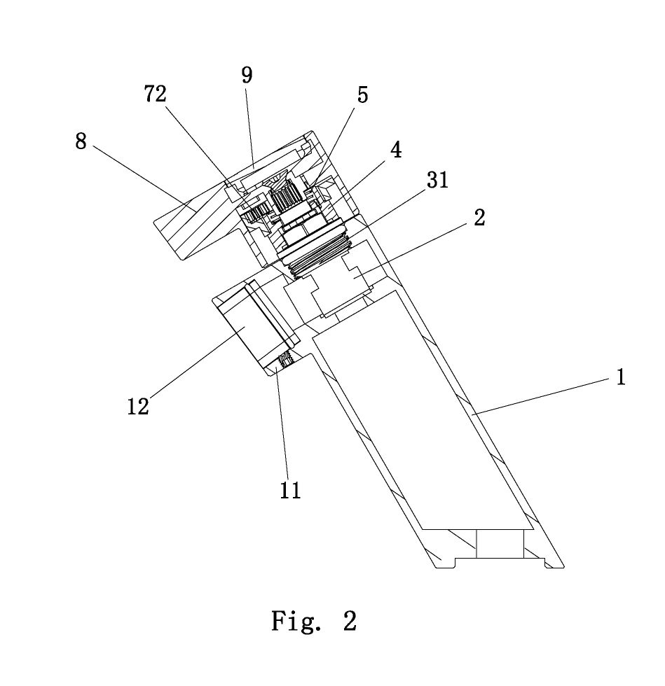

With reference to FIGS. 1 and 2, it is to be noted that a faucet equipped with the water saving mechanism includes a body 1, a core 2 having a connection seat 3 integrally formed with the core 2, a positioning seat 4, a restoring spring 5, a bracket 6, a limit 7, a handle 8 and a cap 9.

The body 1 normally is a hollow elongated annular-shaped body and has a hollow nose 11 extending out from a portion of the body 1 and a water aerator 12 securely received inside the nose 11 for misting the runner water flowing through and out of the body 1.

The connection seat 3 is integrally formed on the core 2 and has an outer threading 31 formed on an outer periphery of the connection seat 3 for threadingly extending into a bore (not numbered) of the body 1 and a hexagonal shaped limit 32 formed on a top circumference of the connection seat 3. In addition, the core 2 further has an extension integrally formed from top of the connection seat 3 and provided with an outer first threading 21 formed on an outer periphery of the extension.

The positioning seat 4 is a hollow annular structure with a bottom thereof constructed to have a shape to adapt to that of the hexagonal shaped limit 32 of the connection seat 3 so that the hexagonal shaped limit 32 is able to be snugly received in the bottom of the positioning seat 4 when the positioning seat 4 is placed on top of the connection seat 3. The positioning seat 4 further has a second threading 41 formed on an outer periphery thereof and at least one (two are shown) adjusting hole 42 defined in an inner periphery of the hollow positioning seat 4.

The restoring spring 5 is received in the hollow positioning seat 4 and has its first free end securely extended into one of the at least one adjusting hole 42 of the positioning seat 4. It is to be noted that recoil force of the restoring spring 5 can be adjusted by selecting different adjusting hole 42 in the positioning seat 4. That is, the scale of the recoil force of the restoring spring 5 is able to be adjusted to adapt to different situations.

The bracket 6 is an annular device and has a third threading 61 formed on an inner circumference thereof to corresponding to and mate with the second threading 41 of the positioning seat 4, a rack 62 formed on a top face of the bracket 6 and a fixing seat 63 supported by poles (not numbered) integrally extended between the fixing seat 63 and the top face of the bracket 6.

The handle 8 is still a hollow structure and shaped as well as sized to receive therein the connection seat 3, the positioning seat 4 and the bracket 6. The handle 8 has a plurality of ribs (not numbered) radially formed inside the hollow handle 8, a hole defined at a joint of the plurality of ribs and a fourth threading 81 formed on an inner periphery of the hole to correspond to and mate with the first threading 21 of the extension of the core 2 and a positioning hole 82 defined in one of the ribs to receive therein the other free end of the restoring spring 5. The limit 7 is provided with a body 71 securely connected to a bottom face of at least one of the ribs via, such as threaded bolts and a ratchet 72 formed on a bottom of the body 71 to correspond to and mate with the rack 62 of the bracket 6.

As can be expected from the drawing that after the extension of the core 2 is extended through the hole of the handle 8, a securing element, such as a threaded bolt 91 is applied to threadingly extend into a free end of the extension of the core 2 to secure relative position between the core 2 and the handle 8. Then the cap 9 is placed on top of the handle 8 to enclose an open end of the handle 8.

With reference to FIG. 2 and still using FIG. 1 for reference, it is clear from the above description that because the positioning seat 4 is snugly connected to the connection seat 3 due to the shape and size of the hollow bottom of the positioning seat 4 and the second threading 41 is threadingly connected to the third threading 61 of the bracket 6, the positioning seat 4 as well as the bracket 6 are still able to move relative to the core 2. Still, even the handle 8 is securely connected to the core 2 via the threaded bolt, there may still room for the handle 8 to move relative to the core 2. However, due to the application of the restoring spring 5 between the handle 8 and the positioning seat 4 and because the third threading 72 is threadingly connected to the rack 62, a recoil force is generated once the handle 8 is moved (rotated). That is, once the handle 8 is moved, e.g., turning on the faucet, the recoil force so generated from the restoring spring 5 will thus drive the handle 8 back to its original position, which turns off the faucet.

Again, because the third threading 72 is mated with the rack 62, while the recoil force is generated due to the movement of the handle 8 to drive the handle 8 back to its original position, the mated third threading 72 and the rack 62 slows down the return of the handle 8, which gradually closes the waterflow out of the faucet.

It is clear from the above description that every time when the handle 8 is moved, i.e., turning on the faucet, a recoil force is stored inside the restoring spring 5. When the force applied to move the handle 8 disappears, the recoil force from the restoring spring 5 drives the handle 8 back to its original position. In the meantime, the ratchet connection between the third threading 72 and the rack 62 gradually slows the returning movement of the handle 8, which accomplishes the goal of automatically turning off the faucet and saving water

After the water saving mechanism of the embodiment of the present invention is applied to the faucet, even the user forgot to turn off the faucet, the faucet will still be automatically turned off and water is saved.

While the invention has been described by means of specific embodiments, numerous modifications and variations could be made thereto by those skilled in the art without departing from the scope and spirit of the invention set forth in the claims.

What is claimed is:

1. A faucet having a body with a core securely mounted thereon and a handle rotatably mounted on top of the core, wherein a recoil mechanism is adapted to be sandwiched between the handle and the body to drive the handle back to its original position as well as slow down return of the handle.

2. The faucet as claimed in claim 1, wherein the recoil mechanism comprises a positioning seat snugly mounted on top of the core and a restoring spring a free end of which is securely connected to the positioning seat and the other free end of which is adapted to securely connect to the handle to drive the handle back to its original position after the handle is rotated.

3. The faucet as claimed in claim 2, wherein the positioning seat has at least one adjusting hole to receive therein a free end of the restoring spring and the handle has a positioning hole to receive therein the other free end of the restoring spring so that a recoil force is applied to the handle after the handle is rotated.

4. The faucet as claimed in claim 2, wherein the recoil mechanism further comprises a bracket sandwiched between the handle and the positioning seat, the bracket is threadingly connected to the positioning seat and in a ratchet connection to the handle.

5. The faucet as claimed in claim 3, wherein the recoil mechanism further comprises a bracket sandwiched between the handle and the positioning seat, the bracket is threadingly connected to the positioning seat and in a ratchet connection to the handle.

6. The faucet as claimed in claim 4, wherein the bracket has a rack formed on a top face thereon and a limit is adapted to be applied to the handle and has a threading formed thereon to correspond to and mate with the rack of the bracket so that when the restoring spring drives the handle back to its original position, the mated threading of the limit and the rack of the bracket slows down movement of the handle.

7. The faucet as claimed in claim 3, wherein there are two adjusting holes in the positioning seat to selectively receive therein the free end of the restoring spring.

8. The faucet as claimed in claim 4, wherein there are two adjusting holes in the positioning seat to selectively receive therein the free end of the restoring spring.

9. The faucet as claimed in claim 5, wherein there are two adjusting holes in the positioning seat to selectively receive therein the free end of the restoring spring.

10. The faucet as claimed in claim 6, wherein there are two adjusting holes in the positioning seat to selectively receive therein the free end of the restoring spring.
